(19) United States
(12) Patent Application Publication
(10) Pub. No.: US 2005/0067093 A1
(43) Pub. Date: Mar. 31, 2005

(54) Process for making disposable diapers

(75) Inventors: Hidefumi Goda, Kagawa-ken (JP); Kenji Takeuchi, Kagawa-ken (JP)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: UNI-CHARM CO., LTD., Kawanoe-shi (JP)

(21) Appl. No.: 10/995,893

(22) Filed: Nov. 24, 2004

Related U.S. Application Data
(63) Continuation of application No. PCT/JP03/07737, filed on Jun. 18, 2003.

(30) Foreign Application Priority Data
Jul. 4, 2002 (JP) 2002-196080

(51) Int. Cl. B32B 31/00

(52) U.S. Cl. 156/265

(57) ABSTRACT

A continuous first web fed in a first machine direction in which absorbent member of disposable diaper is to be obtained is coated on its outer surface with a hot melt adhesive agent, then guided and cut between upper and lower tool rolls to form the individual absorbent members. The absorbent member is guided between the lower tool roll and a guide roll so that the adhesive agent may be pressed against a peripheral surface of the guide roll and then fed onto a reorienting roll. After having been reoriented on the reorienting roll, the absorbent member is bonded to second web fed in a second machine direction by means of the adhesive agent. Preferably, both the upper tool roll and the lower tool roll have diameters smaller than a diameter of the reorienting roll.

### BACKGROUND OF THE INVENTION

The present invention relates to a process for making disposable diapers.

Japanese Patent Application Publication No. 1992-161152A discloses a process for making absorbent articles such as disposable diapers. According to the process disclosed in this Publication, a web sheet which is a series of individual absorbent bodies and extends in a machine direction is coated on one surface with an adhesive agent and then this web sheet is guided between a roll serving as a cutting means and a roll serving as a reorienting means and cut to obtain the individual absorbent bodies. The individual absorbent bodies are successively rotated around their own axes on the reorienting means by 90° from the machine direction to a transverse direction orthogonal to the machine direction and then joined to the outermost sheet fed in the machine direction so that the individual absorbent bodies are placed on the outermost sheet intermittently in the machine direction.

In the above-cited known process, the roll serving as a cutting means is provided on its peripheral surface with a blade extending in an axial direction of the roll and commonly called as an upper tool. The roll serving as a reorienting means has its peripheral surface which the upper tool hits and is commonly called as a lower tool. The peripheral surface of the roll serving as a cutting means has a relatively small circumferential dimension which usually corresponds to a length of one or two individual absorbent bodies. The roll serving as a reorienting means has a circumferential length sufficient to support at least two individual absorbent bodies on its peripheral surface and to allow one of these two individual absorbent bodies to rotate around its own axis. With a consequence, in many cases, the roll serving as a reorienting means has a diameter as large as three to five times of the diameter of the roll serving as a cutting means. Since the blade and the peripheral surface which the blade hits are liable to be worn during continuous use of these two rolls, these two rolls need periodic maintenance and checks as well as periodic exchanges of parts. Regarding this, the roll serving also as the lower cutter requires much time and labor for maintenance, checks and parts-exchanges because of its relatively large diameter. The hot melt type adhesive agent commonly used in the process for making a disposable diaper may also raise a problem. Depending on a viscosity at which the hot melt type adhesive agent is applied, a layer of the coated adhesive agent may be unnecessarily thick. In consequence, the article such as diaper may be uncomfortably stiff.

### SUMMARY OF THE INVENTION

It is an object of the present invention to provide a process for continuously making a disposable diaper improved so as to facilitate maintenance, checks and parts-changes of upper and lower tools to make a thickness of an adhesive layer light.

According to the present invention, there is provided a process for continuously making a disposable diaper generally comprising the steps of coating an outer surface of a first cover sheet of a first web including said first continuous cover sheet, a second cover sheet fed in a first machine direction and a plurality of blocks made of body fluid absorbent material and interposed between these two cover sheets and arranged intermittently in the first machine direction with an adhesive agent, cutting the first web in a transverse direction orthogonal to the first machine direction between respective pairs of adjacent the blocks to obtain individual absorbent members, reorienting the individual absorbent members from the first machine direction to the transverse direction, and bonding the individual absorbent members to a second web comprising a continuous sheet fed in a second machine direction orthogonal to the transverse direction so that at least a part of each of the individual absorbent members constitutes a crotch region of the diaper and at least a part of the second web constitutes a waist region of the diaper.

The improvement according to the present invention is characterized in that an adhesive agent is a hot melt adhesive agent, the first web coated with the adhesive agent is guided between upper and lower tool rolls extending in the transverse direction in parallel to each other, the first web is cut by these rolls between respective pairs of adjacent the blocks to obtain the individual absorbent members, the absorbent members are guided between the lower tool roll and a guide roll extending in the transverse direction in parallel to each other with a hot melt adhesive agent on the first cover sheet pressed against a peripheral surface of the guide roll, then the individual absorbent members are transferred from the guide roll to a reorienting roll extending in parallel to the guide roll with the second cover sheet placed against a peripheral surface of the reorienting roll, the individual absorbent members are successively reoriented from the first machine direction to the transverse direction on the reorienting roll and then the individual absorbent members are fed onto the second web and bonded to the second web by means of a hot melt adhesive agent.

The present invention includes the following embodiments.

The peripheral surface of the guide roll is adapted to be temperature-adjustable.

Diameters of the upper and lower tool rolls are substantially equal to each other and smaller than that of the reorienting roll.

The process according to the present invention for making the disposable diaper is primarily characterized in that the first web is cut between the upper and lower tool rolls to obtain the individual body fluid absorbent members which are then squeezed between the lower tool roll and the guide roll and then fed onto the reorienting roll. Such a unique process allows the diameters of the upper and lower tool rolls to be reduced in order to facilitate maintenance and check of these rolls as well as exchange of the parts. The layer of the hot melt adhesive agent applied on the individual body fluid absorbent member is pressed against the peripheral surface of the guide roll and there by flatten out and thinned. The disposable diaper obtained according to this process is free from the inconvenience that the hot melt adhesive agent layer might result in a feeling of stiffness and become undesirably thick.

### BRIEF DESCRIPTION OF THE DRAWINGS

FIG. 1 is a partially cutaway plan view showing a disposable diaper;

FIG. 2 is a partially cutaway perspective view showing the disposable diaper of an arrangement different from the arrangement shown in FIG. 1; and

FIG. 3 is a diagram illustrating a part of the process for making the disposable diaper.

### DETAILED DESCRIPTION OF THE PREFERRED EMBODIMENTS

Details of the process according to the present invention for making disposable diaper will be more fully understood from the description given hereunder with reference to the accompanying drawings.

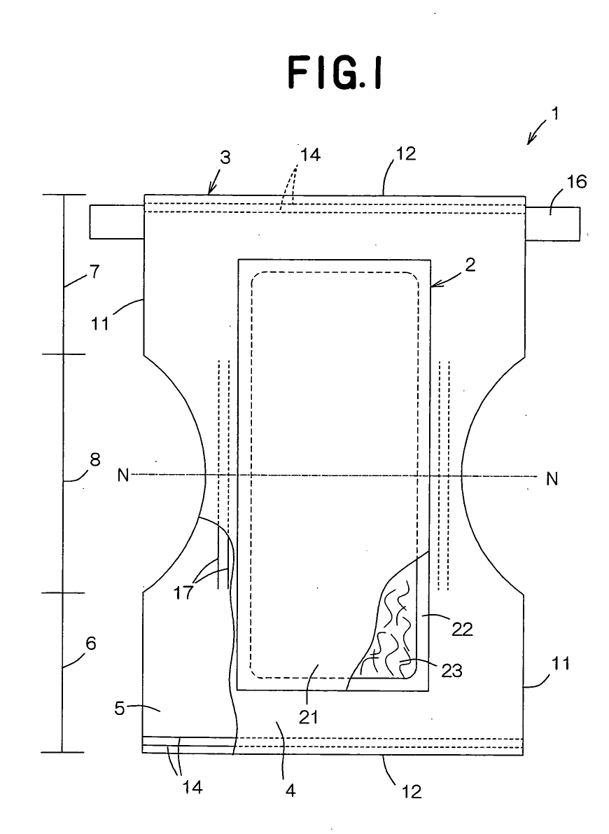

FIG. 1 is a partially cutaway plan view showing an open-type disposable diaper 1 according to this invention. The diaper 1 generally comprises a body fluid absorbent member 2 having a rectangular shape dimensioned to be longer in a longitudinal direction of the diaper 1 and an hourglass-shaped sheet-like support member 3. Configurationally, the diaper 1 is composed of, as viewed in the longitudinal direction, a front waist region 6, a rear waist region 7 and a crotch region 8 extending between these two waist regions 6, 7. A dimension of the diaper 1 in the longitudinal direction is bisected by a center line N-N.

The support member 3 includes an inner sheet 4 facing a wearer's body and an outer sheet 5 facing a wearer's undergarment, both being adhesively or thermally joined to each other. The support member 3 at least partially defines the front waist region 6, the rear waist region 7 and the crotch region 8. In the front and rear waist regions 6, 7, waist-surrounding elastic members 14 extend in a transverse direction of the diaper 1 between these inner and outer sheets 4, 5 and are secured in a stretched state to at least one of these sheets 4, 5. The inner and outer sheets 4, 5 are liquid-pervious or liquid-impervious and made of a suitable material such as a plastic film or a nonwoven fabric.

The body fluid absorbent member 2 includes a liquid-pervious topsheet 21, liquid-impervious or liquid-pervious backsheet 22 and a block 23 which is interposed between these top- and backsheets 21, 22 and made of body absorbent material. The topsheet 21 and the backsheet 22 are overlaid and joined together outside along a peripheral edge of the block 23 using a suitable adhesive agent or a heat-sealing technique. The body fluid absorbent member 2 in which the block 23 is covered with the topsheet 21 and the backsheet 22 in this manner extends in the crotch region 8 further into the front and rear waist regions 6, 7 wherein the backsheet 22 is bonded to the inner sheet 4 by means of an adhesive agent (not shown). In this manner, the body fluid absorbent member 2 makes a part of these respective regions 6, 7, 8. In the case of the backsheet 22 which is liquid-pervious, the inner sheet 4 or the outer sheet 5 is preferably liquid-impervious. The disposable diaper constructed as has been described above can be worn in same manner as a well-known open-type disposable diaper.

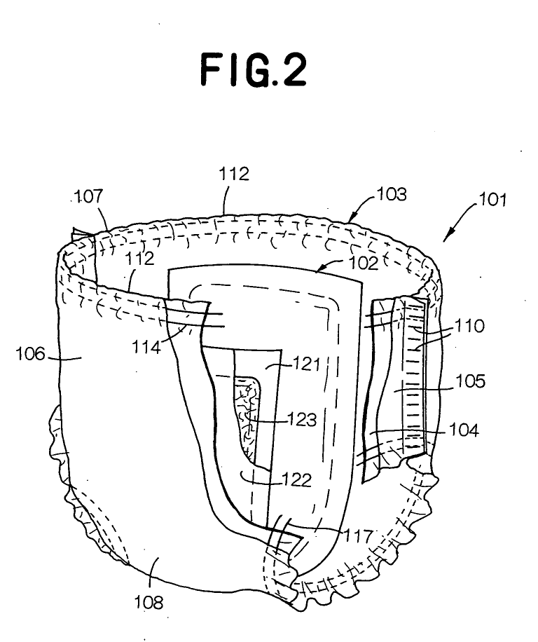

FIG. 2 is a partially cutaway perspective view showing a pants-type disposable diaper 101 obtained by the process according to the invention. The diaper 101 comprises a pants-shaped support member 103 and a body fluid absorbent member 102 attached to an inner side of the support member 103. The support member 103 at least partially defines a front waist region 106, a rear waist region 107 and a crotch region 108. The front and rear waist regions 106, 107 are overlaid and joined together at a plurality of joining lines 110. Such the diaper 101 can be obtained by folding the diaper 1 of FIG. 1 with the body fluid absorbent member 2 inside along the center line N-N and then joining the front and rear waist regions 6, 7 together in the vicinity of transversely opposite side edge zones 11 of the respective waist regions 6, 7. However, tape fasteners 16 as seen in FIG. 1 are unnecessary to obtain the diaper 101 of FIG. 2 from the diaper 1 of FIG. 1 and may be previously eliminated. The regions, portions and zones in the diaper 101 of FIG. 2 which correspond to those in the diaper 1 of FIG. 1 are designated by the reference numerals in FIG. 1 added with 100, respectively.

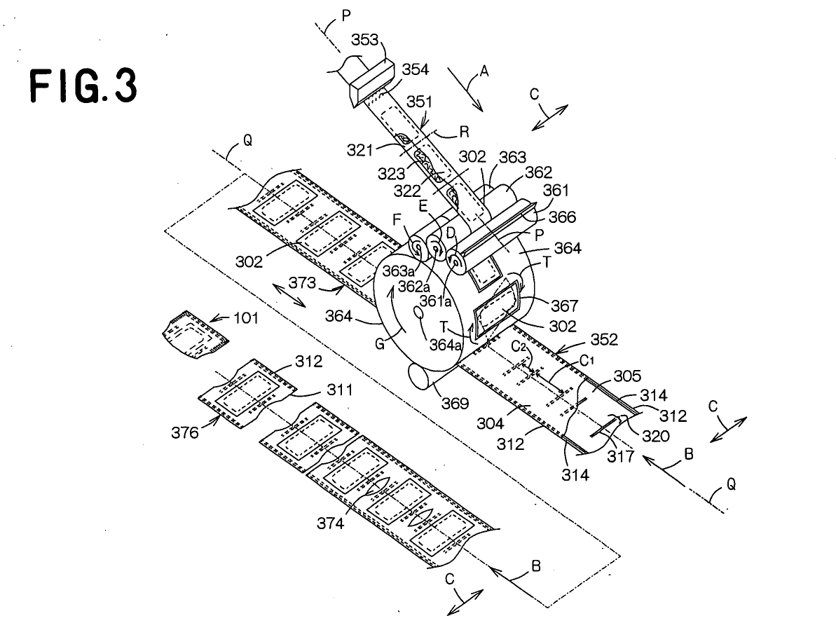

FIG. 3 is a perspective diagram illustrating a part of the process for continuously making the diaper 1 or the diaper 101. In the upper part of the diagram, a first web 351 is fed in a first machine direction indicated by an arrow A and, in the lower part of the diagram, a second web 352 is fed in a second machine direction indicated by an arrow B. A direction indicated by an arrow C which is orthogonal to the first machine direction A is orthogonal also to the second machine direction B. While center lines P, Q extending to bisect the first web 351 and the second web 352, respectively, in the transverse direction C are illustrated to lie on the same plane orthogonal to the transverse direction C, it is also possible to arrange these two center lines P, Q so as to be spaced one from another in the transverse direction C. Of these first and second webs 351, 352, the second web 352 comprises a continuous inner sheet 304 and a continuous outer sheet 305 placed upon and joined to each other. Between the continuous inner sheet 304 and the continuous outer sheet 305, a plurality of first elastic members 314 continuously extending in a stretched state in the second machine direction B and a plurality of second elastic members 317 extending in a stretched state in a transverse direction of the second web 352, i.e., in the transverse direction C are interposed. The first elastic members 314 lie in the vicinity of transversely opposite side edges of 312 extending in parallel to each other and are bonded to at least one of the sheets 304, 305. A plurality of second elastic members 317 lie in a group 320 in a transversely middle zone of the second web 352 so that these groups 320 are spaced one from another in the second machine direction B alternately by a relatively small dimension C₁ and a relatively large dimension C₂. The second elastic members 317 are bonded to at least one of the sheets 304, 305.

In the upper part of FIG. 3, the first web 351 comprising a continuous topsheet 321, a continuous backsheet 322 and an absorbent block 323 interposed between these two sheets 321, 322 is illustrated to be fed in the first machine direction A. As illustrated, the absorbent blocks 323 each having a rectangular shape which is relatively long in the first machine direction A and arranged intermittently in the first machine direction A. The continuous topsheet 321 and the continuously backsheet 322 are overlaid and joined together outside along peripheral edges of the respective blocks 323 by use of a suitable adhesive agent or a heat-sealing technique. Such the first web 351 is fed with its continuous backsheet 322 facing upward in the first machine direction A and, in the course of being fed in this manner, the continuous backsheet 322 is coated by an adhesive coater 353 with a hot melt adhesive agent 354 in a desired pattern.

The first web 351 fed in the first machine direction A and the second web 352 fed in the second machine direction B are integrated together by means of an upper tool roll 361, a lower tool roll 362, a guide roll 363, a reorienting roll 364 and a press roll 369 as shown in FIG. 3. The upper tool roll 361 and the lower tool roll 362 respectively rotate in directions indicated by arrows D, E around axes 361a, 362a extending in parallel to each other in a direction orthogonal to the first machine direction A. The upper tool roll 361 is provided on its peripheral surface with a blade 366 extending in parallel to the axis 361a so that the blade 366 may come in contact with a smooth peripheral surface of the lower tool roll 362 under an adjustable pressure. The lower tool roll 362 is formed on its peripheral surface with a plurality of vacuum suction openings (not shown). The lower tool roll 362 and the guide roll 363 respectively rotate in directions indicated by arrows E, F around axes 362a, 363a extending in parallel to each other so that one of these axes 362a, 363a may be shifted to adjust a distance between these two rolls 362, 363 and/or to adjust a contact pressure of the rolls 362, 363 when these two rolls 362, 363 rotate with the first web 351 interposed therebetween. A peripheral surface of the guide roll 363 is formed by material such as a silicone rubber or a fluorocarbon resin so that the hot melt adhesive agent 354 in a molten or semi-molten state may be easily separated from the peripheral surface. In addition, this peripheral surface is temperature-adjustable so that the hot melt adhesive agent 354 may be maintained in adhesively effective condition and separated from the peripheral surface in a stable condition. The guide roll 363 is also provided on its peripheral surface with a plurality of vacuum suction openings (not shown). The reorienting roll 364 extends in parallel to the guide roll 363 and rotates around on an axis 364a in a direction indicated by an arrow G. The reorienting roll 364 is provided on its peripheral surfaces with a plurality of rotary tables 367 intermittently arranged around the axis 364a. While details are not illustrated, each of these rotary tables 367 rotates on the peripheral surface of the roll 364 around this table's own axis by 90° in a direction indicated by an arrow T during ½ rotation of the reorienting roll 364 in the direction G and then rotates on the peripheral surface of the roll 364 around this table's own axis by 90° in a direction opposite to the direction T during the subsequent ½ rotation of the roll 364. The axis 363a of the guide roll 363 may be shifted to ensure that the guide roll 363 is brought in contact with the peripheral surfaces of the rotary tables 367 or spaced apart from the peripheral surface of the rotary tables 367 by a desired dimension.

The first web 351 is fed in the first machine direction toward these rolls 361, 362, 363 and 364. The first web 351 having the continuous backsheet 322 coated with the hot melt adhesive agent 354 and facing upward is first guided between the upper tool roll 361 and the lower tool roll 362. The first web 351 fed in close contact with the peripheral surface of the lower tool roll 362 under the vacuum suction is then transferred onto the guide roll 363. On the peripheral surface of the lower tool roll 362, the first web 351 is cut by the blade 366 of the upper tool roll 361 along an imaginary line R transversely extending between each pair of the adjacent blocks 323, 323 made of an absorbent material into the individual body fluid absorbent members 302. The individual body fluid absorbent members 302 are pressed by the lower tool roll 362 against the peripheral surface of the guide roll 363 and at the same time retained on this peripheral surface of the guide roll 363 under the vacuum suction from this roll 363. Then the individual body fluid absorbent members 302 are guided to the reorienting roll 364. The hot melt adhesive agent 354 in a molten or semi-molten condition is pressed against the peripheral surface of the guide roll 363 as the body fluid absorbent members 302 are pressed against the peripheral surface of the guide roll 363. Consequently, the hot melt adhesive agent 354 is flattened out on the entire surface of the backsheet 322 and a layer of the adhesive agent 354 is correspondingly thinned. The vacuum suction from the lower tool roll 362 is stopped when the body fluid absorbent member 302 is separated from the lower tool roll 362.

The vacuum suction from the guide roll 363 is stopped when the body fluid absorbent member 302 on the guide roll 363 comes in contact with the associated rotary table 367 on the reorienting roll 364 and at the same time this body fluid absorbent member 302 is transferred with the backsheet 322 facing upward to the associated rotary table 367 under the vacuum suction from the vacuum suction openings (not shown) of the rotary table 367.

The reorienting roll 364 is opposed to the guide roll 363 lying immediately above the reorienting roll 364 and opposed to the press roll 369 lying immediately below the reorienting roll 364 as viewed in the vertical direction in FIG. 3. During ½ rotation of the reorienting roll 364 around the axis 364a from the guide roll 363 toward the press roll 369 in the direction G, the rotary table 367 rotates around its own axis by 90° in the direction T. So the body fluid absorbent member 302 oriented heretofore in the first machine direction A, i.e., in the direction orthogonal to the axis 364a of the reorienting roll 364 is reoriented so as to extend in parallel to the axis 364a , i.e., in the transverse direction C. The body fluid absorbent member 302 is squeezed together with the second web 352 between these two rolls 364, 369 as the reorienting roll 364 is opposed to the press roll 369 to join the body fluid absorbent member 302 to the continuous inner sheet 304 of the second web 352 by means of the hot melt adhesive agent 354 and thereby to form a third web 373. In this third web 373, each of the body fluid absorbent members 302 is interposed between each pair of the adjacent groups 320, 320 of the second elastic members 317 spaced apart from each other by the relatively large dimension C₁. The vacuum suction from the rotary table 367 is stopped when the associated body fluid absorbent member 302 is joined to the second web 352.

The third web 373 is further fed in the second machine direction B and subjected to a step of cutting out. Specifically, substantially disc-shaped portions of the inner and outer sheets 304, 305 placed upon each other are successively cut out from the third web 373 to form openings 374 between each pair of the adjacent groups 320, 320 of the second elastic members 317 spaced apart from each other by the relatively small dimension C₂. The third web 373 is then cut between each pair of adjacent groups 320, 320 of the second elastic members 317 spaced apart from each other by the relatively small dimension C₂ thereby to form individual assemblies 376. Each of the assemblies 376 is contoured by longitudinally opposite ends 312 corresponding to the transversely opposite side edges 312 continuously extending in the second machine direction B and transversely opposite side edges 311 extending in the direction C orthogonal to the second machine direction B. The side edges 311 are defined by the bisected disc-shaped zones so as to describe circular arcs curving inward, respectively.

The assembly 376 may be provided in the vicinity of one of the longitudinally opposite ends 312 with tape fasteners (not shown) extending outward from the transversely opposite side edges 311, respectively. The assembly 376 obtained in this manner corresponds to the diaper 1 of FIG. 1 in which the inner sheet 4 and the outer sheet 5 are defined by the inner sheet 304 and the outer sheet 305 in the assembly 376, respectively, and the absorbent member 2 is defined by the body fluid absorbent member 302. The tape fasteners 16 in FIG. 1 are defined by the tape fasteners with which the assembly 376 may be provided.

The assembly 376 may be folded with the body fluid absorbent member 302 inside in the transverse direction C, then the inner and outer sheets 304, 305 may be overlaid and joined together in the vicinity of the transversely opposite side edges 311, respectively, to obtain the pants-type diaper 101 of FIG. 2. In this case, the inner and outer sheets 304, 305 are destined to define the inner and outer sheets 104, 105 in FIG. 2. The body fluid absorbent member 302 is destined to define the absorbent member 102 in FIG. 2.

With the process according to the invention for continuously making the disposable diaper as has been described above, a circumferential dimension of the upper tool roll 361 may be set to be substantially equal to the body fluid absorbent member 302 as measured in the first machine direction A to minimize a diameter of the upper tool roll 361. While the lower tool roll 362 and the guide roll 363 may have respective diameters smaller than the diameter of the upper tool roll 361, it is preferred that these rolls 362, 363 have the diameters substantially equal to the diameter of the upper tool roll 361. In view of the fact that the reorienting roll 364 must have a plurality of rotary tables 367 and these rotary tables 367 must rotate their own axes, this reorienting roll 364 usually has a diameter as large as three to five times of the diameter of the upper tool roll 361. It should be understood here that the present invention allows the diameters of the upper tool roll 361 and the lower tool roll 362 to be reduced independently of the diameter of the reorienting roll 364 in order to facilitate maintenance and/or check of these rolls, exchange of the blade 366, mounting and/or demounting of these rolls. Furthermore, the invention allows the layer of the hot melt adhesive agent 354 to be pressed against the easily-releasable peripheral surface of the guide roll 363 and thereby to be flattened out over the entire surface of the backsheet 322. Such the layer of the adhesive agent 354 is not only thin and flexibly deformable but also allows the body fluid absorbent member 302 to be bonded to the second web 352 over an area as large as possible. The body fluid absorbent member 302 and the second web 352 may be squeezed between the reorienting roll 364 and the press roll 369 to press the layer of the hot melt adhesive agent 354 applied on the body fluid absorbent member 302 to be pressed against the second web 352. In this case, however, it is apprehended that the hot melt adhesive agent 354 might adhere to the continuous backsheet 322 of the body fluid absorbent member 302 made of nonwoven fabric or plastic film and the continuous inner sheet 304 of the second web 352. This phenomenon makes it difficult to flatten out and thereby to thin the layer of the hot melt adhesive agent 354.

The invention is not limited to the illustrated embodiment and without departing from spirit and scope of the invention it is possible to attach the elastic members in a stretched state so as to extend in the first machine direction A to the side edges of the first web 351. The second web 352 may be replaced by the web formed by nonwoven fabric or plastic film having none of the first elastic members 314 and the second elastic members 317 bonded thereto. While the first machine direction A and the second machine direction B are illustrated in the accompanying diagram to be opposite to each other, it is also possible to coincide these two machine directions with each other.

1. A process for continuously making disposable diapers generally comprising the steps of coating an outer surface of a first cover sheet of a first web including said first continuous cover sheet, a second continuous cover sheet fed in a first machine direction and a plurality of blocks made of body fluid absorbent material and interposed between these two cover sheets and arranged intermittently in said first machine direction with an adhesive agent, cutting said first web in a transverse direction orthogonal to said first machine direction between respective pairs of adjacent said blocks to obtain individual absorbent members, reorienting said individual absorbent members from said first machine direction to said transverse direction and bonding said individual absorbent members to a second web comprising a continuous sheet fed in a second machine direction orthogonal to said transverse direction so that at least a pair of each of said individual absorbent members constitutes a crotch region of said diaper and at least a part of said second web constitutes a waist region of said diaper, said process being characterized in that:
an adhesive agent is a hot melt adhesive agent; and
said first web coated with an hot melt adhesive agent is guided between upper and lower tool rolls extending in said transverse direction in parallel to each other, said first web is cut by these rolls between respective pairs of adjacent said blocks to obtain said individual absorbent members, said absorbent members are then guided between said lower tool roll and a guide roll extending in said transverse direction in parallel to each other with a hot melt adhesive agent on said first cover sheet pressed against a peripheral surface of said guide roll, then said individual absorbent members are transferred from said guide roll to a reorienting roll extending in parallel to said guide roll with said second cover sheet placed against a peripheral surface of said reorienting roll, said individual absorbent members are successively reoriented from said first machine direction to said transverse direction on said reorienting roll and then said individual absorbent members are fed onto said second web and bonded to said second web by means of a hot melt adhesive agent.

2. The process according to claim 1, wherein said peripheral surface of said guide roll is adapted to be temperature-adjustable.

3. The process according to claim 1, wherein diameters of said upper and lower tool rolls are substantially equal to each other and smaller than that of said reorienting roll.
